(19) United States
(12) Patent Application Publication
(10) Pub. No.: US 2023/0222265 A1
(43) Pub. Date: Jul. 13, 2023

(54) CONSTRUCTION DESIGN SYSTEM WITH GENETIC ALGORITHM

(71) Applicant: Daisy Al Inc., Vancouver (CA)

(72) Inventors: Luke WHALE, Eastleigh (GB); Christopher KNIGHT, Feltham (GB); Mohammadmahdi KERAMATI, London (GB)

(21) Appl. No.: 17/575,544

(22) Filed: Jan. 13, 2022

(51) Int. Cl. G06F 30/27; G06F 30/12; G06F 30/13

(52) U.S. Cl. CPC G06F 30/27; G06F 30/12; G06F 30/13; G06F 2111/06

(57) ABSTRACT

A framing optimization method and framing optimization system that generates a plan using concepts of a genetic algorithm. The framing optimization method first receives a boundary of a framing task then generates a plan having at least one primary frame member and at least one secondary frame member. Generating the plan includes generating at least one primary frame member which defines at least one zone in the boundary. Each primary frame member has respective first values of length, width, and location. Further, the method generates at least one secondary frame member. Each secondary frame member has respective second values of length, width, and location. The method further optimizes, using a genetic algorithm, the plan by repeatedly generating preliminary plans using the at least one primary frame member and the at least one secondary frame member.

### TECHNICAL FIELD

Example embodiments relate to building construction, for example, generating framing layouts and plans for building construction purposes.

### BACKGROUND

A structure, such as a building or house, may have multiple levels, for instance, a basement, a first level, and so on. The basement floor is usually made of concrete slabs, which is the foundation of the structure. However, the first level floor, or any other floor apart from the basement, is likely not made of poured concrete; instead, the non-basement floors are usually made of framing members such as beams, joists, panel products, and other elements. Beams are load-bearing framing members of the structure. These beams are supported by walls and posts generally erected from the basement. Beams may support the joists, or the joists may be supported directly by the walls and columns. On top of the beams and joists are the panel products which may be plywood, engineered wood, or other materials. The panel products are usually of rectangular shapes and support flooring and decorative materials such as hardwood, tiles, carpet, concrete, paint, staining/sealing, etc., to be installed on top of the panel products.

The beams, joists, and panel products are the structure's flooring system and are designed and constructed in a specific arrangement, referred to as a framing layout. Framing layouts should at least meet specified framing requirements. These specified framing requirements may be contained in a framing standard or code setting out the minimum necessary structural, fire, acoustic or insulation requirements for the floor to be acceptable in a particular country or region, or to a specific clients requirements.

Framing is usually performed manually by experienced individuals using computer-aided design software to generate a plan (interchangeably referred to as framing layout) detailing locations, sizes, materials, and other features of the framing members. The individuals generating the plan often first concentrate on the arrangement of beams and joists, without consideration of the size of the panel products which need to be laid on top of the elements. These individuals usually generate multiple plans, spending around 20 minutes for each plan, then another two to three hours to choose a plan that best meets the specified framing requirements and is cost effective.

Framing is a daunting task. Perhaps there are at least thousands of arrangements for the beams and joists for a given project. As well, different materials may be used. Such materials may have different properties and prices, also sizes. For example, solid lumber used to be the only material used for joists; however, laminated-veneer lumber and other proprietary engineered wood joist and beam products are also now commonly used and accepted. Further, the directions of the framing members add another degree of freedom, so as the spacing between the framing members.

Therefore, it would be desirable to provide methods and systems for optimizing framing that may require less time and cost to generate a plan than generating the plan manually using experienced individuals.

### SUMMARY

Example embodiments include a framing optimization method and framing optimization system that generates a plan (interchangeably referred to as framing layout) using concepts of a genetic algorithm. The plan meets the specified framing requirements and may reduce one or more costs associated with the plan. Further, the specified framing requirements may include user-specified framing requirements related to material options or user preferences for the framing optimization to meet.

The plan has details about primary frame members (beams) and secondary frame members (joists), including each frame member's width, length, and location. The plan is an optimized plan selected from a plurality of preliminary plans over multiple iterations using the genetic algorithm. In each iteration of the genetic algorithm, the preliminary plans undergo mutation and crossover. During mutation, some values of at least one primary frame member and/or secondary frame member are changed. There are two types of mutations: high-level mutation and low-level mutation, depending on the number of changes made to the preliminary plan. During crossover, primary frame members and/or secondary frame members are swapped between two preliminary plans.

According to one example embodiment is a framing optimization method. The framing optimization method includes receiving a boundary of a framing task; and generating a plan having at least one primary frame member and at least one secondary frame member for the framing task within the boundary. Generating the plan includes generating at least one primary frame member which defines at least one zone in the boundary. Each primary frame member has respective first values of length, width, and location. Generating the plan further includes generating at least one secondary frame member. Each secondary frame member has respective second values of length, width, and location. Further, the method includes optimizing, using a genetic algorithm, the plan by repeatedly generating preliminary plans using the at least one primary frame member and the at least one secondary frame member.

In some embodiments, at least one secondary frame member is supported by at least one of the at least one primary frame member. In other embodiments, the boundary includes walls and posts. In some embodiments, the optimizing meets specified framing requirements which include deflection, strength, and/or vibrational performance. In other example embodiments, the specified framing requirements comprise a minimum requirement for meeting a standard.

In example embodiments, the framing optimization method further comprises receiving user-specified framing requirements from a graphical user interface for generating the plan.

In example embodiments, the user-specified framing requirements include a number of agents for the genetic algorithm. In other example embodiments, the user-specified framing requirements include a number of iterations for the genetic algorithms.

In example embodiments, optimizing the plan is performed, for each of the preliminary plans, by generating another one or more of the preliminary plans, by at least one of: generating another at least one primary frame member; generating another at least one secondary frame member; removing one or more of the at least one primary frame member; removing one or more of the at least one secondary frame member; changing one or more of the first values of the length, the width, or the location of one or more of the at least one primary frame member; or changing one or more of the second values of the length, the width, or the location of one or more of the at least one secondary frame member.

In example embodiments, optimizing the plan is performed, for each of the preliminary plans, by generating another one or more of the preliminary plans, by at least two of: generating another at least one primary frame member; generating another at least one secondary frame member; removing one or more of the at least one primary frame member; removing one or more of the at least one secondary frame member; changing one or more of the first values of the length, the width, or the location of one or more of the at least one primary frame member; or changing one or more of the second values of the length, the width, or the location of one or more of the at least one secondary frame member.

In example embodiments, optimizing of the plan is performed, for each of the preliminary plans, by generating another one or more of the preliminary plans, by all of: generating another at least one primary frame member; generating another at least one secondary frame member; removing one or more of the at least one primary frame member; removing one or more of the at least one secondary frame member; changing one or more of the first values of the length, the width, or the location of one or more of the at least one primary frame member; and changing one or more of the second values of the length, the width, or the location of one or more of the at least one secondary frame member.

In example embodiments, optimizing the plan further comprises optimizing a function based on one or more cost values of material, process, wastage, or delivery.

In example embodiments, optimizing the plan optimizes a loss function. In example embodiments, the loss function includes determining global minima. In some example embodiments, optimizing the plan optimizes a fitness function. In other example embodiments, optimizing the fitness function includes determining global optima.

In example embodiments, optimizing the plan further comprises optimizing a reduction in cost of material cutting of the at least one primary frame member and/or the at least one secondary frame member.

According to other examples, optimizing the plan further comprises optimizing a reduction in cost of material cutting of panel products to be supported by the at least one primary frame member or the at least one secondary frame member. According to example embodiments, the plan is a floorplan.

In some example embodiments, the framing task is floorplan framing; each of the at least one primary frame member is a beam; and each of the at least one secondary frame member is a joist.

In some example embodiments, receiving the boundary further comprises receiving at least one frame-free zone, the at least one frame-free zone comprising a second boundary of the frame-free zone within the boundary of the framing task, passing the at least one primary frame member or the at least one secondary frame member through the at least one frame-free zone violates construction principles. According to some example embodiments, at least one primary frame member is generated along the second boundary of the frame-free zone.

In some example embodiments, generating the at least one primary frame member and generating the at least one secondary frame member is performed using a machine learning model configured, through training from a training dataset, to generate the at least one primary frame member and the at least one secondary frame member.

In some example embodiments, generating the at least one primary frame member or generating the at least one secondary frame member is performed by assigning random values to the first values of the at least one primary frame member and the second values of the at least one secondary frame member.

In some example embodiments, generating the at least one primary frame member or generating the at least one secondary frame member is performed by assigning values to the first values of the at least one primary frame member and the second values of the at least one secondary frame member heuristically gathered from persons experienced in producing plans for assigning values to the first values of the at least one primary frame member and the second values of the at least one secondary frame member.

In some example embodiments, optimizing the plan using the genetic algorithm is performed over multiple iterations, each iteration of the genetic algorithm comprising generating at least two preliminary plans, each preliminary plan being generated by crossover between two preliminary plans of a previous iteration performed by swapping the at least one primary frame member and the at least one secondary frame member for the at least one zone between the two preliminary plans.

In some example embodiments, optimizing the plan using the genetic algorithm is performed over multiple iterations, each iteration of the genetic algorithm comprising generating at least one preliminary plan. Each preliminary plan is generated by a first level mutation of one of the at least one preliminary plan by regenerating the at least one primary frame member and the at least one secondary frame member from the at least one zone.

In some example embodiments, optimizing the plan using the genetic algorithm is performed over multiple iterations, each iteration of the genetic algorithm comprising generating at least one preliminary plan. Each preliminary plan is generated by a second level mutation of one of the at least one preliminary plan by introducing changes to at least one of the first values of the at least one primary frame member or at least one of the second values of the at least one secondary frame member.

According to one example embodiments is a framing optimization system. The framing optimization system comprises a processing device; and a memory coupled to the processing device. The memory tangibly stores thereon executable instructions that, when executed by the processing device, cause the processing device to receive a boundary of a framing task; and generate a plan having at least one primary frame member and at least one secondary frame member for the framing task within the boundary. Generating the plan includes generating at least one primary frame member which defines at least one zone in the boundary. Each primary frame member has respective first values of length, width, and location. Generating the plan further includes generating at least one secondary frame member. Each secondary frame member has respective second values of length, width, and location. Further, generating the plan includes optimizing, using a genetic algorithm, the plan by repeatedly generating preliminary plans using the at least one primary frame member and the at least one secondary frame member.

In example embodiments, at least one secondary frame member is supported by at least one of the at least one primary frame member. In other example embodiments, the boundary includes walls and posts.

In some example embodiments, optimizing meets specified framing requirements which include deflection, strength, and/or vibrational performance. In other example embodiments, the specified framing requirements comprise a minimum requirement for meeting a standard.

In example embodiments, the executable instructions that, when executed by the processing device, further cause the processing device to receive user-specified framing requirements from a graphical user interface for generating the plan. In example embodiments, the user-specified framing requirements include a number of agents for the genetic algorithm. In example embodiments, the user-specified framing requirements include a number of iterations for the genetic algorithms.

In example embodiments, optimizing the plan is performed, for each of the preliminary plans, by generating another one or more of the preliminary plans, by at least one of: generating another at least one primary frame member; generating another at least one secondary frame member; removing one or more of the at least one primary frame member; removing one or more of the at least one secondary frame member; changing one or more of the first values of the length, the width, or the location of one or more of the at least one primary frame member; or changing one or more of the second values of the length, the width, or the location of one or more of the at least one secondary frame member.

In example embodiments, optimizing the plan is performed, for each of the preliminary plans, by generating another one or more of the preliminary plans, by at least two of: generating another at least one primary frame member; generating another at least one secondary frame member; removing one or more of the at least one primary frame member; removing one or more of the at least one secondary frame member; changing one or more of the first values of the length, the width, or the location of one or more of the at least one primary frame member; or changing one or more of the second values of the length, the width, or the location of one or more of the at least one secondary frame member.

In example embodiments, optimizing the plan is performed, for each of the preliminary plans, by generating another one or more of the preliminary plans, by all of: generating another at least one primary frame member; generating another at least one secondary frame member; removing one or more of the at least one primary frame member; removing one or more of the at least one secondary frame member; changing one or more of the first values of the length, the width, or the location of one or more of the at least one primary frame member; and changing one or more of the second values of the length, the width, or the location of one or more of the at least one secondary frame member.

In example embodiments, optimizing the plan further comprises optimizing a function based on one or more cost values of material, process, wastage, or delivery. In other example embodiments, optimizing the plan optimizes a loss function. In example embodiments, optimizing the loss function includes determining global minima.

In some example embodiments, optimizing the plan optimizes a fitness function. In other example embodiments, optimizing the fitness function includes determining global optima.

In example embodiments, optimizing the plan further comprises optimizing a reduction in cost of material cutting of the at least one primary frame member and/or the at least one secondary frame member.

In some example embodiments, optimizing the plan further comprises optimizing a reduction in cost of material cutting of panel products to be supported by the at least one primary frame member or the at least one secondary frame member.

In some example embodiments, the plan is a floorplan.

In some example embodiments, the framing task is floorplan framing; each of the at least one primary frame member is a beam; and each of the at least one secondary frame member is a joist.

In some example embodiments, receiving the boundary further comprises receiving at least one frame-free zone. The at least one frame-free zone comprises a second boundary of the frame-free zone within the boundary of the framing task. Passing the at least one primary frame member or the at least one secondary frame member through the at least one frame-free zone violates construction principles. In other example embodiments, the at least one primary frame member is generated along the second boundary of the frame-free zone.

According to example embodiments, generating the at least one primary frame member and generating the at least one secondary frame member is performed using a machine learning model configured, through training from a training dataset, to generate the at least one primary frame member and the at least one secondary frame member.

According to example embodiments, generating the at least one primary frame member or generating of the at least one secondary frame member is performed by assigning random values to the first values of the at least one primary frame member and the second values of the at least one secondary frame member.

In some example embodiments, generating the at least one primary frame member or generating the at least one secondary frame member is performed by assigning values to the first values of the at least one primary frame member and the second values of the at least one secondary frame member heuristically gathered from persons experienced in producing plans for assigning values to the first values of the at least one primary frame member and the second values of the at least one secondary frame member.

In some example embodiments, optimizing the plan using the genetic algorithm is performed over multiple iterations, each iteration of the genetic algorithm comprising generating at least two preliminary plans. Each preliminary plan is generated by crossover between two preliminary plans of a previous iteration performed by swapping the at least one primary frame member and the at least one secondary frame member for the at least one zone between the two preliminary plans.

In other example embodiments, optimizing the plan using the genetic algorithm is performed over multiple iterations. Each iteration of the genetic algorithm comprises generating at least one preliminary plan. Each preliminary plan is generated by a first level mutation of one of the at least one preliminary plan by regenerating the at least one primary frame member and the at least one secondary frame member from the at least one zone.

In example embodiments, optimizing the genetic algorithm is performed over multiple iterations, each iteration of the genetic algorithm comprising generating at least one preliminary plan. Each preliminary plan is generated by a second level mutation of one of the at least one preliminary plan by introducing changes to at least one of the first values of the at least one primary frame member or at least one of the second values of the at least one secondary frame member.

According to another example embodiment is another framing optimization method. The framing optimization method includes receiving a boundary of a framing task, and generating, using a machine learning model, a plan having at least one primary frame member and at least one secondary frame member for the framing task within the boundary. Generating the plan includes generating at least one primary frame member which defines at least one zone in the boundary. Each primary frame member has respective first values of length, width, and location. Generating the plan further includes generating at least one secondary frame member. Each secondary frame member has respective second values of length, width, and location.

In some example embodiments, the machine learning model optimizes the plan based on one or more cost values of material, process, wastage, or delivery. In other example embodiments, the machine learning model is a genetic algorithm. In other example embodiments, the at least one secondary frame member is supported by at least one of the at least one primary frame member.

In some example embodiments, the machine learning model is trained using labelled training datasets generated from the framing optimization method of any of the above that used the genetic algorithm, each of the labelled training datasets including: i) the boundary of the plan from the framing optimization method of any of the above that used the genetic algorithm, and ii) the at least one primary frame member of the plan generated by the framing optimization method of any of the above that used the genetic algorithm and the at least one secondary frame member of the plan generated by the framing optimization method of any of the above that used the genetic algorithm.

### BRIEF DESCRIPTION OF THE FIGURES

The features and advantages of example embodiments will become apparent from the following detailed description, taken in combination with the appended drawings, in which:

FIG. 1 shows a block diagram of a processing system in which the technology of the framing optimization method may be implemented in accordance with some example embodiments.

FIG. 2 illustrates a block diagram of a framing optimization module for performing the framing optimization method of FIG. 1 in accordance with some example embodiments.

FIG. 3 shows primary frame members, secondary frame members, and frame-free zone in a plan in accordance with some example embodiments.

FIG. 4 is a diagram of operations performed by the primary frame member generator module of the framing optimization module in accordance with some example embodiments.

FIG. 5 illustrates an example explaining possible second preliminary plans generated by the secondary frame member generator module of the framing optimization in accordance with some example embodiments.

FIG. 6 is a flowchart of a framing optimization method performed in the optimizer module of the framing optimization module in accordance with some example embodiments.

FIG. 7 shows an example illustrating the crossover step of the optimization process of FIG. 6 performed in the optimizer module in accordance with some example embodiments.

FIG. 8 shows an example illustrating the high-level mutation step of the optimization process of FIG. 6 performed in the optimizer module in accordance with some example embodiments.

FIG. 9 is a graphical user interface for receiving the specified framing requirements, including the user-specified framing requirements, in accordance with some example embodiments.

FIG. 10 is a flowchart describing the framing optimization method in accordance with some example embodiments.

It is to be understood that throughout the appended drawings and corresponding descriptions, like features are identified by like reference characters. Furthermore, it is also to be understood that the drawings and ensuing descriptions are intended for illustrative purposes only and are not intended to be limiting.

### DETAILED DESCRIPTION

Various representative embodiments will be described more fully hereinafter with reference to the accompanying drawings. However, the example embodiments may be embodied in many different forms and should not be construed as limited to the representative embodiments set forth herein. In the drawings, the sizes and relative sizes of layers and regions may be exaggerated for clarity. Like numerals refer to like elements throughout. Some non-limiting examples to illustrate various implementations of aspects of example embodiments are described below.

Example embodiments relate to building construction, for example, framing optimization methods and framing optimization systems for optimizing framing patterns for building construction purposes. Example embodiments of the framing optimization method can be applied to the scenario in which a building is to be constructed. For example, a floor layout is provided that has boundaries. The framing optimization method can generate and output locations and types of primary frame members (beams) and secondary frame members (joists) for the floor layout. The generated locations and types of the primary frame members and secondary frame members are optimized to meet standards and user-specified framing requirements. The layout of the floor includes the boundaries such as walls and posts and also includes framing-free zones, which are zones where the framing optimization method should not generate primary framing members and secondary framing members for. Stairwells, for example, are framing-free zones.

To generate primary frame members and secondary frame members for the floor layout, the framing optimization method uses concepts of genetic algorithms, which includes generating preliminary plans, either randomly or using machine learning. Each preliminary plan includes an arrangement (e.g. locations and types) of primary framing members and secondary framing members. The framing optimization method uses the genetic algorithm to then mutate and crossover a subset of the preliminary plans to generate further preliminary plans. This process is repeated until an optimized plan is generated.

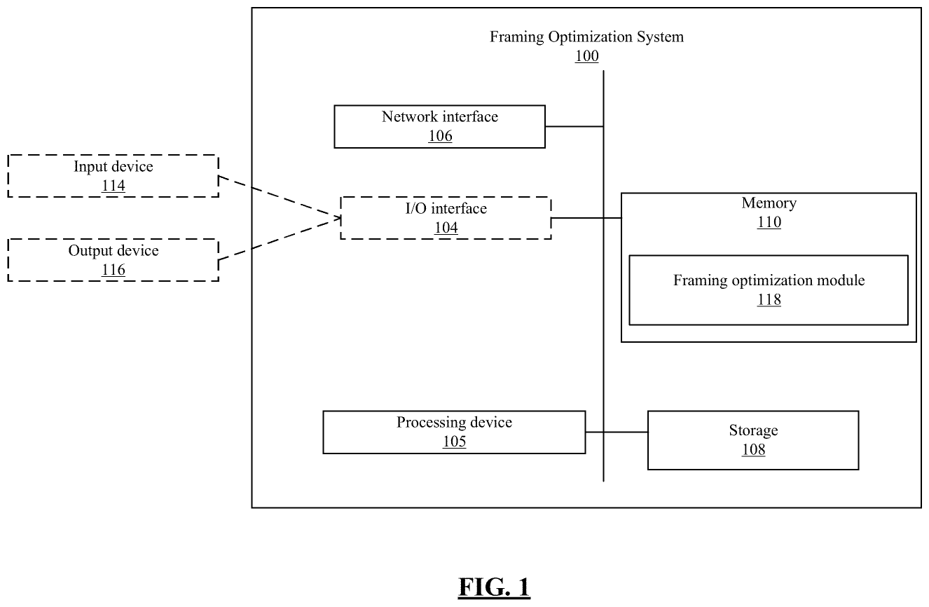

FIG. 1 is a block diagram of a framing optimization system 100, which may be used to implement embodiments of the framing optimization method. Other processing systems may be suitable for implementing example embodiments and may include components different from those discussed below. Although FIG. 1 shows a single instance of each component, there may be multiple instances of each component in the processing system 100.

The framing optimization system 100 can be used during the design of a building to frame each floor, apart from the basement. The frame (interchangeably referred to as plan) of a floor may have beams supported by walls and posts, and joists supported by walls, posts, and beams. Above the beams and joists are panel products which are the base for decorative elements and flooring such as tiles, hardwood, carpet, concrete, paint, staining/sealing, etc. In an example embodiment, the framing optimization system 100 receives a layout containing boundaries. In an example embodiment, the framing optimization system 100 generates and outputs a plan of an optimized framing for the layout. The framing optimization system 100 generates multiple preliminary plans and uses the concept of genetic algorithm to generate and select the plan that is optimized to meet specified framing requirements.

The processing system 100 may include one or more processing devices 105, such as a processor, a microprocessor, a graphics processing unit (GPU), a tensor processing unit (TPU), an application-specific integrated circuit (ASIC), a field-programmable gate array (FPGA), a dedicated logic circuitry, or combinations thereof. The processing system 100 may optionally include one or more input/output (I/O) interfaces 104, to enable interfacing with one or more optional input devices 114 and/or optional output devices 116. The processing system 100 may include one or more network interfaces 106 for wired or wireless communication with other processing systems 100. The network interface(s) 106 may include wired links (e.g., Ethernet cable) and/or wireless links (e.g., one or more antennas) for intra-network and/or inter-network communications.

The processing system 100 may also include one or more storage unit(s) 108, which may include a mass storage unit such as a solid-state drive, a hard disk drive, a magnetic disk drive and/or an optical disk drive. In some example embodiments, the storage unit(s) 108 may include data of various framing members (primary and secondary) and panel products such as sizes, materials, material properties and characteristics and other aspects necessary for framing optimization. Although FIG. 1 can include the storage unit(s) 108 having framing member data, in other examples this framing member data may be received from one or more remote storage unit(s) that can be accessed remotely via a wireless or a wired network. The processing system 100 can be a server (e.g. a cloud server).

The processing system 100 may include one or more non-transitory memories 110, which may include a volatile or a non-volatile memory (e.g., a flash memory, a random access memory (RAM), and/or a read-only memory (ROM)). The non-transitory memory(ies) 110 may store instructions for execution by the processing device(s) 105, such as to carry out example framing optimization methods in the example embodiments. The memory(ies) 110 may store other software (e.g., instructions for execution by the processing device(s) 105), such as an operating system and other applications/functions. In some embodiments, one or more datasets and/or modules may be provided by an external memory (e.g., an external drive in wired or wireless communication with the processing system 100) or may be provided by a transitory or non-transitory computer-readable medium. Examples of non-transitory computer-readable media include a RAM, a ROM, an erasable programmable ROM (EPROM), an electrically erasable programmable ROM (EEPROM), a flash memory, a CD-ROM, or other portable memory storage. In an embodiment, memory(ies) 110 stores a framing optimization module 118, which may be a software system that includes machine-readable instructions that are stored in the memory(ies) 110 and are executable by the processing device 105.

In an example, the framing optimization module 118 receives a boundary of a framing task. The framing task may be a floorplan framing where the task of the framing optimization module 118 is to arrange and select beams and joists to meet the specified requirements. Framing optimization module 118 outputs a plan meeting the specified framing requirements, including construction principles and other user-specified framing requirements, such as optimizing material cost, labour, and reducing waste. In some embodiments, framing optimization module 118 may not be a set of instructions in the memory 110 but rather a standalone module in the processing system 100. In example embodiments, the framing optimization module 118 may be stored in a remote processing system such as a server (e.g. a cloud server) and accessed by a user device (not shown here) using the network interface 106.

In FIG. 1, the optional input device(s) 114 (e.g., a keyboard, a mouse, a microphone, a camera, a touchscreen integrated into a display device which may include a UI and/or a keypad) and optional output device(s) 116 (e.g., a display device which may include a UI, a speaker and/or a printer) are shown as external to the processing system 100. In other examples, one or more of the optional input device(s) 114 and/or the optional output device(s) 116 may be an internal component of the processing system 100.

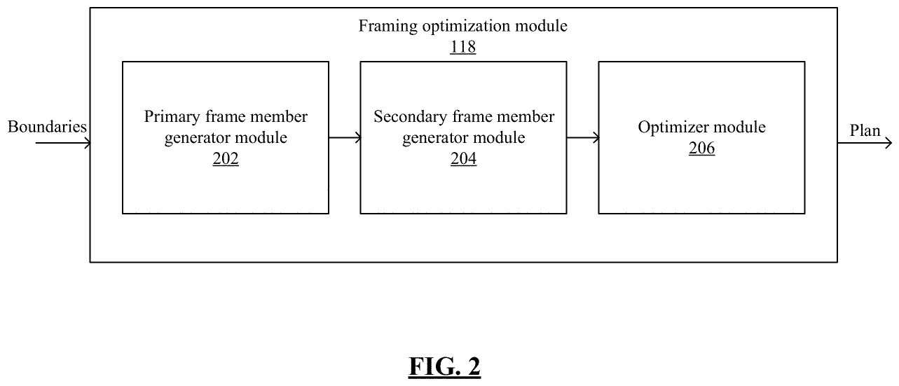

FIG. 2 is a block diagram showing components of the framing optimization module 118. Framing optimization module 118 receives the boundaries of a framing task. For example, suppose the framing task is a floorplan. In that case, the framing optimization module 118 receives the boundaries as a layout of the floorplan, including frame-free zones such as the location of staircase, chimney, service vault, etc., which put constraints as to where framing members can be added. In other words, the floorplan is defined by a set of external walls, internal walls, posts, and frame-free zones. The primary frame member generator module 202 receives the framing task's boundaries and generates a plurality of first preliminary plans. Each first preliminary plan at this stage has primary frame members only. The first preliminary plans are received by the secondary frame member generator module 204 to generate the secondary frame members for each of the plurality of first preliminary plan. The output of the secondary frame member generator module 204 is a plurality of second preliminary plans. Hence, each of the plurality of second preliminary plans includes both primary frame members and secondary frame members.

Each frame member, primary or secondary, has multiple values, including length, width, and location. Other values may include material type, price, strength, deflection and vibration characteristics, fire, acoustic and insulation properties. The optimizer module 206 receives the plurality of second preliminary plans, which have both the primary and secondary frame members and optimize values of the primary and secondary frame members to generate a plan. The plan abides by specified framing requirements, such as construction principles, regulatory construction requirements, and user-specified framing requirements, and may optimize cost, including one or a combination of material, process, wastage, and delivery. The specified framing requirements may include information such as deflection, strength, and/or vibrational performance of the material used for the primary frame members and the secondary frame members, as well as their desired fire, acoustic or thermal insulation performance. The user-specified framing requirements can include the original pre-cut size (length and width) of the primary frame members, the secondary frame members, and the panel products.

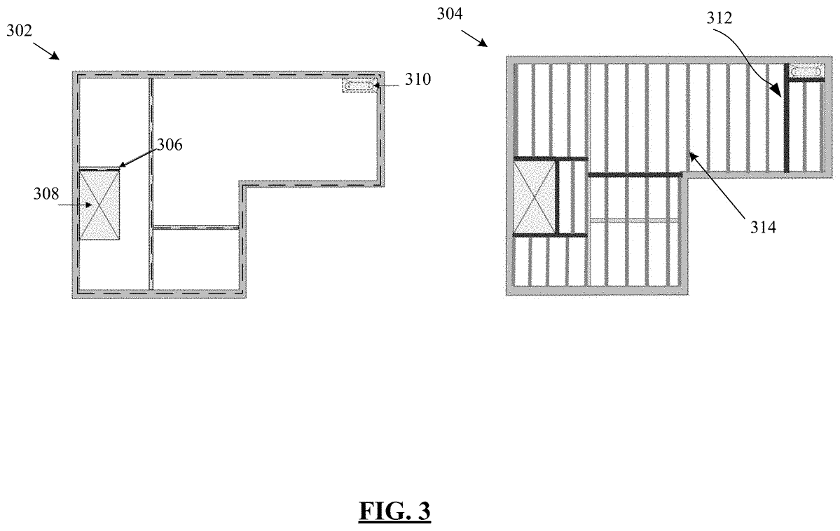

Referring to FIG. 3, the first layout 302 illustrates example boundaries of a framing task received by the framing optimization module 118, and the second layout 304 illustrates an example plan generated by the framing optimization module 118. The first layout 302 shows the boundaries, such as walls 306, and frame-free zones with boundaries such as staircase 308 and a service void 310. The dashed line in the first layout 302 represents walls.

The output of the framing optimization module 118 may be the second layout 304, which is the plan (framing layout). The plan includes the primary frame members 312, one of which is labelled, and the secondary frame members 314, one of which is labelled. It can be observed that neither the primary nor the secondary frame members pass through the staircase 308 and the service void 310, since these are designated as frame-free zones. Passing frame members (primary or secondary) through the frame-free zones violates construction principles.

The primary frame member generator module 202, the secondary frame member generator module 204, and the optimizer module 206 are further described in detail below. The primary frame member generator module 202 generates primary frame members within the boundaries of the framing task, excluding the boundaries of frame-free zones. For every primary frame member generated, two disjoint zones are defined.

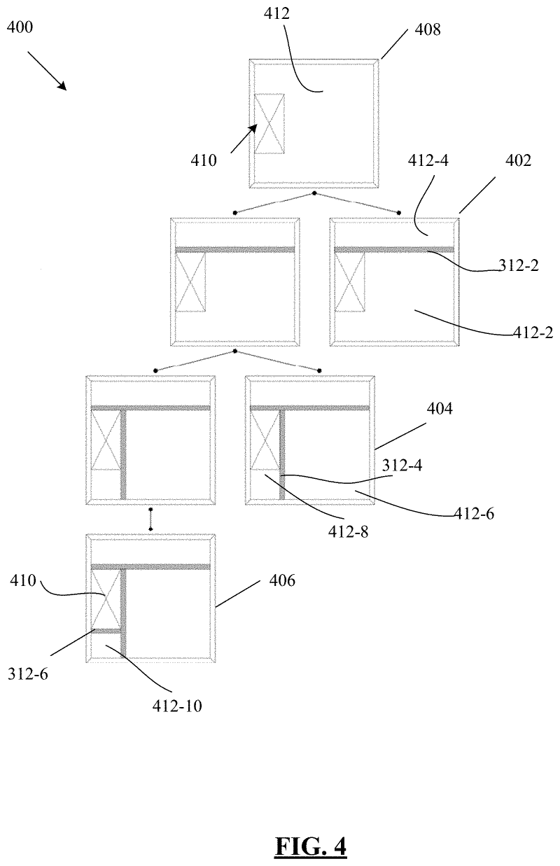

FIG. 4 illustrates the generation of multiple first preliminary plans as a binary tree 400. A child of every node (leaf) may be a first preliminary plan, which has primary frame members only. For instance, the first preliminary plans of the binary tree 400 are preliminary plans 402, 404, 406.

The primary frame member generator module 202 generates at least one primary frame member 312, a specific primary frame member will be referred to as 312-2, 312-4, . . . , and a general primary frame member will be referred to as 312. In this example embodiment, the primary frame member generator module 202 receives the boundaries 408, including frame-free zone 410. The boundaries 408 encompass a zone 412. The primary frame member generator module 202 generates the primary frame member 312-2, and consequently defines two disjoint zones 412-2, 412-4. Further, the primary frame member generator module 202 generates another primary frame member splitting zone 412-2 into two disjoint zones 412-6, 412-8. The zone 412-8 includes the frame-free zone as well. Further, the primary frame member generator module 202 generates another primary frame member 312-6, defining two disjoint zones 412-10, 410, where 410 is the frame-free zone.

In this example embedment, three first preliminary plans 402, 404, 406 are generated, which are provided to the secondary frame member generator module 204 to generate secondary frame members 314 for each first preliminary plan. Generating secondary frame members 314 for each zone generates a respective second preliminary plan.

The example embodiment of FIG. 4 shows only a subset of the first preliminary plans generated by the primary frame member generator module 202. The preliminary plans generated in FIG. 4 are just examples and not limiting. A person skilled in the art can identify other locations to generate the primary frame members 312, which will generate additional preliminary plans.

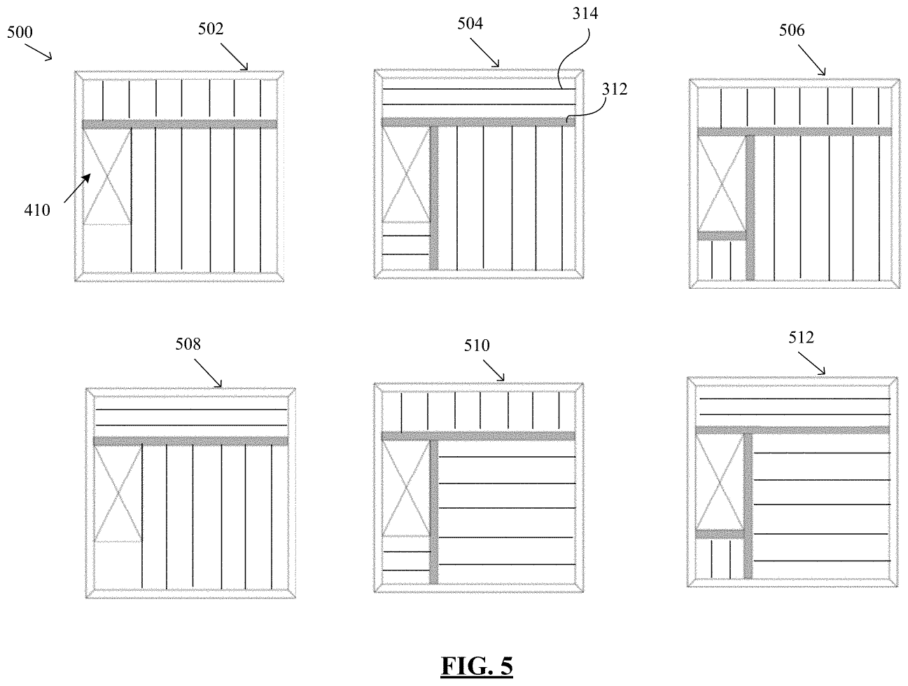

FIG. 5 illustrates examples of preliminary plans 500 generated by the secondary frame member generator module 204 resulted after generating the secondary frame members 314. The secondary frame member generator module 204 receives the plurality of first preliminary plans generated by the primary frame member generator module 202 and generates second preliminary plans by generating secondary frame members for each zone. The second preliminary plans shown in FIG. 5 is a subset of possible second preliminary plans generated by the secondary frame member generator module 204. Generally, each zone has secondary frame members in one direction, vertical or horizontal or parallel or perpendicular to the primary frame members if they are orientated at an angle.

The second preliminary plans 502, 504, 506, 508, 510, 512 are generated by generating secondary frame members in each zone of the first preliminary plans 402, 404, 406 in the secondary frame member generator module 204. Each second preliminary plan 502, 504, . . . , 512 is unique in the subset of possible second preliminary plans for the first preliminary plans. These second preliminary plans 502, . . . , 512 are just examples and not meant to be limiting. All second preliminary plans generated in the secondary frame member generator module 204 are provided to the optimizer module 206 to compute and optimize costs, ensure compliance with the specified framing requirements, and output a plan selected from the second preliminary plans.

The primary frame member generator module 202 and the secondary frame member generator module 204 generate the primary and secondary frame members by either assigning random values to respective frame member (primary or secondary) location, width, and length, and other values if exist, or by using heuristics which have been gathered from persons who are experienced in producing optimal floor plan layouts for a variety of conditions. Therefore, a person skilled in the art appreciates that a multitude of preliminary plans (first and second) may be generated. Preliminary plans (first or second) that do not comply with the specified framing requirements are removed from the respective set of preliminary plans (first or second). In example embodiments, compliance is evaluated in the optimizer module 206. In other example embodiments, compliance can be evaluated in the primary frame member generator module 202, secondary frame member generator module 204, or both.

Example embodiments may include the primary frame member generator module 202 and the secondary frame member generator module 204 implementing a machine learning model configured through training by a training dataset to generate the first preliminary plans and the second preliminary plans. The training dataset has plans meeting the specified framing requirements. Several machine learning models (algorithms) may be used to generate the preliminary plans (first or second), including supervised and unsupervised machine learning models.

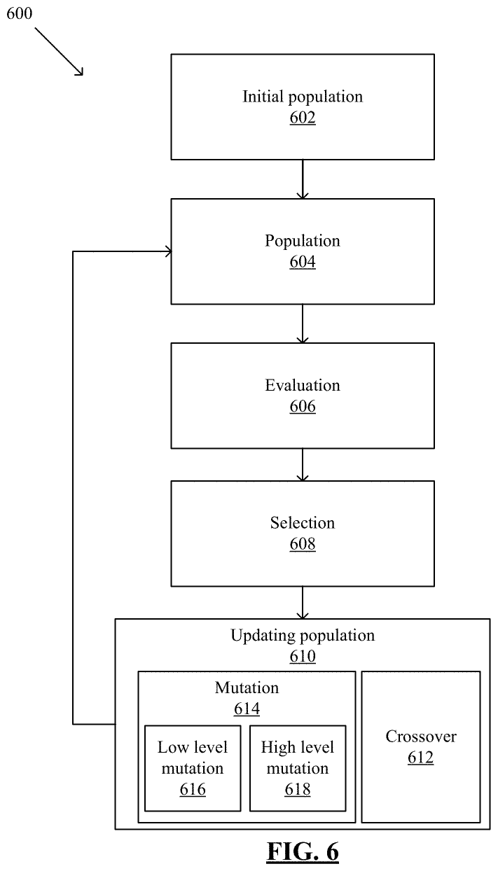

FIG. 6 is a flowchart illustrating the framing optimization method 600 performed in the optimizer module 206. The optimizer module 206 receives the plurality of second preliminary plans generated in the secondary frame member generator module 204. The optimizer module 206 may implement a genetic algorithm, which is an optimization method inspired by the process of natural selection. Genetic algorithm (GA) starts with initial solutions, which are the second preliminary plans generated by the secondary frame member generator module 204, and iteratively and gradually improves the second preliminary plans until the algorithm arrives at an optimized preliminary plan, which is selected as the plan outputted from the optimizer module 206. To be consistent with the genetic algorithm language in the art, the second preliminary plans may be interchangeably referred to as agents.

The framing optimization method 600 starts by the processing device 105 receiving an initial population of agents at step 602. This initial population of agents contains the second preliminary plans generated by the secondary frame member generator module 204. The processing device 105 then iterates until reaching an optimized plan that meets the specified framing requirements. For the first iteration, the processing device 105 considers the agents in the initial population at step 602 as the population at step 604. At step 606, every agent in the population is evaluated for compliance whether each agent meets the specified framing requirements. The specified requirements include construction principles, which may be framing standards that the framing task should abide by at minimum. The specified framing requirements may also include user-specified framing requirements, such as using a specific type of material, having a plan with extra material, etc. Further, the evaluation step 606 computes a function for each agent. The function is used in the optimization. The function may be a fitness function that reflects the fitness of the agent, which may have a scalar value reflecting how well the agent meets the framing requirements. Similarly, the function may be a loss function. In general, the function value may be the objective function value that the optimizer module 206 optimizes.

Example embodiments include a function having a value of one or a combination of cost values of the material, process, wastage, and/or delivery. Example embodiments include a function having a value optimized for reducing material cutting cost. For instance, for floor framing, the frame has primary frame members (beams), secondary frame members (joists), panel products (e.g., boards above the frame members, also called floorboards). The primary frame members, secondary frame members, and panel products typically are provided (purchased) from the supplier in a particular uncut size of width, length, and depth. Following construction principles, each panel product has to start from a support and end at a support, the support being beams, joists, walls, posts, etc. Panel products must not end at an empty space, e.g. hanging between joists. If a panel product ends at an empty space, the panel product would need to be cut to end at a support. This cutting incurs extra labour costs for cutting, material, and waste (lost material ends from the cutting). Thus, an example embodiment includes the function for reducing material cuttings by having the beams (primary frame members) and joists (secondary frame members) at locations that reduce such cutting loss. Example embodiments may include a function having a value optimized for reducing material cutting costs. For such embodiments, optimization is performed for one or more of the number of cuts of primary frame members, secondary frame members, or panel products.

The process completes step 606 and proceeds to step 608. In the selection process at step 608, the processing device 105 selects three subsets for example: agents to retain for the next iteration, agents that undergo crossover at step 612, and agents that undergo mutation at step 614. In this example embodiment, the three subsets are disjoint. However, the sets may overlap in other example embodiments.

The subset of retained agents for the next iteration has two subsets for example: agents evaluated at step 606 to be the best agents (e.g. agents with the best function value) and some randomly selected agents. The best agents are selected as follows. If the function is a fitness function, then the best agents have the highest function values; however, if the function is a cost function, then the best agents have the lowest function values. These best agents are retained to ensure that agents with the best function values are not removed during crossover at step 612 or mutation at step 614. Further, the randomly selected agents are retained to add diversity to the population of the next-generation (e.g. population of next iteration).

Through this iterative process, best agents get a higher chance of passing genomes (primary frame members and secondary frame members) to the next generation; the agents get better and better until the function converges to an optimal value.

In scenarios where the function is a cost function, the function in some example embodiments converges to global minima, while in other example embodiments, the function converges to local minima. In scenarios where the function in a fitness function, the function in some example embodiments converges to global maxima, while in other example embodiments, the function converges to local maxima.

At step 610, the population is updated, which includes two processes: crossover at step 612 and mutation at step 614. The crossover, at step 612, generates crossover agents (crossover preliminary plans) for the next iteration. Each crossover agent is generated by swapping the primary frame members and the secondary frame members of one zone of an agent (first parent) with the primary frame members and secondary frame members of another zone of another agent (second parent). The primary frame members and secondary frame members may be referred to as genomes of an agent. The crossover agents generated from crossing over the parents may also be referred to as a child.

Two sub-steps are performed at step 614, which is the mutation step, a low-level mutation at step 616 and a high-level mutation at step 618. For the low-level mutation, at step 616, the processing device 105 introduces small random changes in the genome of an agent, such as changing one value of a primary frame member and/or one value of the secondary frame members of a zone. An example of a low-level mutation is changing the width value of the primary frame member. This small change may change the function value of that agent for better or worse.

High changes are performed for the high-level mutation at step 618, including regenerating the primary frame members and/or the secondary frame members of a zone or more of an agent. This high change may change the function value of that agent, also for better or worse. The low-level mutation and high-level mutation each generates mutated agents for the next iteration.

Therefore, the population at step 604 of the next iteration has the retained agents, the crossover agents generated from the crossover process at step 612, and the mutated agents generated in the mutation process at step 614. After updating the population at step 610, the processing device 105 completes the iteration and starts another iteration.

This example embodiment may evaluate the compliance of agents with the specified framing requirements at step 606. The specified framing requirements include construction principles and standards, which are the minimum requirements, and also include user-specified framing requirements, for example, a specific type of material, or preference for extra strength, etc.

However, other example embodiments may have the primary frame member generator module 202 and the secondary frame member generator module 204 configured to generate primary frame members and secondary frame members, respectively, compliant with the specified framing requirements. Any first preliminary plan or second preliminary plan not compliant may be discarded and not provided to the subsequent stage. In other words, if a first preliminary plan is not compliant with the specified framing requirements, then the first preliminary plan is not provided to the secondary frame member generator module 204. Further, if a second preliminary plan, generated in the secondary frame member generator module 204, is not compliant with the specified framing requirements, then the second preliminary plan is not provided to the optimizer module 206.

In one scenario, the primary frame member generator module 202 and the secondary frame member generator module 204 are configured to evaluate the compliance of agents with the specified framing requirements. Referring back to FIG. 4, for this scenario, only the first preliminary plan 406 of the first preliminary plans 402, 404, 406 are provided to the secondary frame member generator module 204. The first preliminary plans 402, 404 are excluded because the boundaries of a frame-free zone, based on construction principles, must have primary frame members. Referring back to FIG. 5, only the second preliminary plans 506, 512 of second preliminary plans 502, 504, 506, 508, 510, 512 are provided to the optimizer module 206, for the same reason above.

Example embodiments may have the primary frame member generator module 202 and the secondary frame member generator module 204 configured to generate primary frame members and secondary frame members, respectively, compliant with the construction principles of the specified framing requirements. Furthermore, compliance with other requirements of the specified framing requirements may be performed in the optimizer module 206. Therefore, evaluation of compliance of agents may be distributed over multiple modules (primary frame member generator module 202, secondary frame member generator module 204, and optimizer module 206).

In an example simulation of the framing optimization method 600, the framing optimization method 600 generated the plan with convergence to the global minima of the cost function after approximately 50 generations (or iterations). This is an efficient way to find the optimal floor framing plan given that there were hundreds of thousands of framing plan permutations possible using all combinations of primary, secondary and floor panel product arrangements.

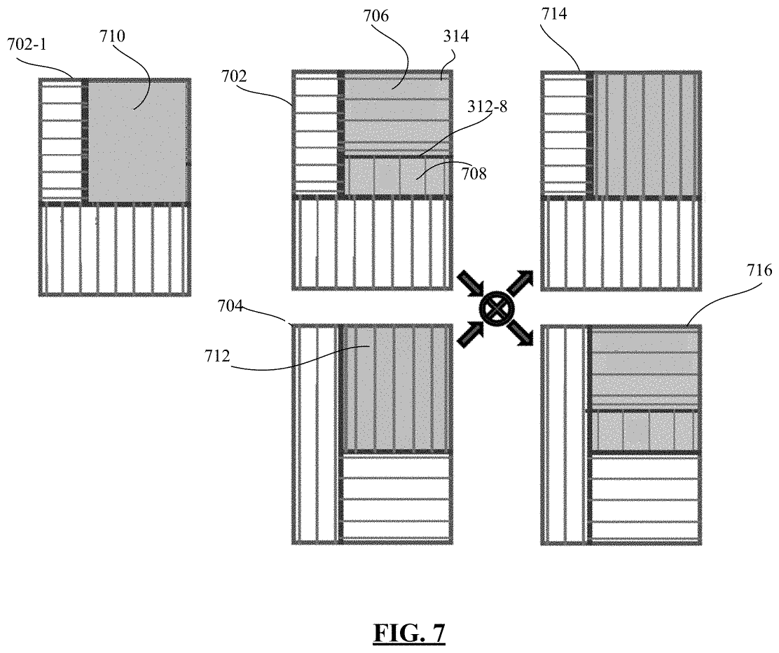

FIG. 7 is an example schematic diagram illustrating the crossover process performed between two agents (second preliminary plans). The crossover process is performed at step 612 of the framing optimization method 600 of FIG. 6. FIG. 7 shows two agents 702, 704; each agent is populated with primary frame members, a specific one is labelled as 312-8, and secondary frame members 314. Agents 702, 704 may also be referred to as parent agents, which are the agents undergoing the crossover process. As discussed previously, generating a primary frame member by the primary frame member generator module 202 defines zones within the received boundaries of a framing task. Among the multiple zones in agent 702 are zone 706 and zone 708.

Agent 702-1 is agent 702 before the primary frame member 312-8 was generated by the primary frame member generator module 202. Agent 702-1 has the zone 710, which is also available in agent 702; however, zone 710 is presented separately for visualization purposes. Therefore, agent 702 also has zone 710 that spans both zones 706 and 708. Further, agent 704 has zone 712.

The process performed for crossover includes finding common zones between two agents. In this example, zone 710 of agent 702-1 (or agent 702) and zone 712 of 704 have the exact same coordinates. The zones that have the exact same coordinates are considered common zones between two agents. During crossover, the primary frame members and secondary frame members are swapped. The same principle can be applied to common zones between agents which have coordinates which are almost but not exactly matched (so-called fuzzy matching).

Swapping zone 710 with zone 712, each with its primary frame members and secondary frame members, generates two agents 714 and 716, which are the child agents for parent agents 702, 704. Agents 714 and 716 are different from agent 702 and agent 704. Agents 714 and 716 are crossover agents used in the population of agents for the next iteration in the genetic algorithm as explained in framing optimization method 600 of FIG. 6.

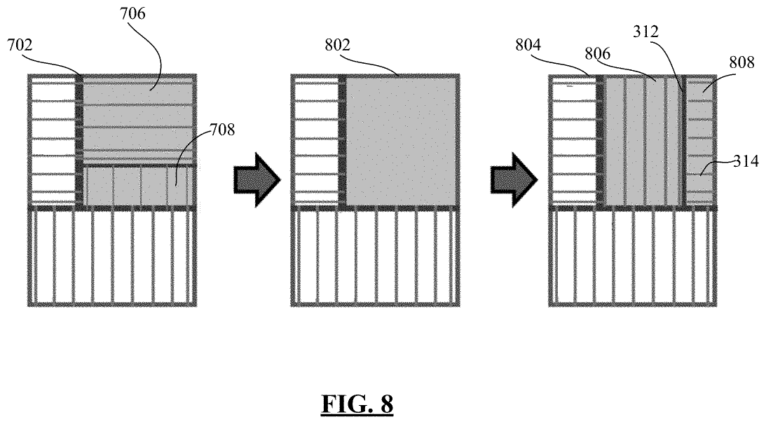

FIG. 8 is an example schematic diagram illustrating the high-level mutation process performed at step 618 of framing optimization method 600 of FIG. 6. The high-level mutation refers to the process of making significant changes in an agent. This is performed by selecting a zone (or more) of an agent and regenerating the primary frame members and secondary frame members using the primary frame member generator module 202 and secondary frame member generator module 204, respectively. This process generates a mutated agent. The purpose of having high-level mutation is to create a lookalike replica of the best agents that may get removed. By performing high-level mutation on an agent and adding the mutated agent to the population for the next iteration, the chance of best agents finding a partner for crossover and passing on their genomes to the next iteration is increased.

FIG. 8 shows agent 702 of FIG. 7 undergoing high-level mutation. In this example embodiment, the primary frame members and secondary frame members of zones 706 and 708 are removed as shown in agent 802. Agent 802 is then further processed in the primary frame member generator module 202 and the secondary frame member generator module 204 to generate a mutated agent with zones 806 and 808 that are different from zones 706, 708 of agent 702. Therefore, agent 804 is a mutated agent of agent 702. This mutated agent 807 has a primary frame member 312 and secondary frame members 314.

This process can similarly be explained differently. Instead of clearing two zones 706 and 708, zone 710 (shown in FIG. 7), which has zones 706, 708, is cleared. Further, it is to be understood that any one or more zones may be cleared and undergo high-level mutation.

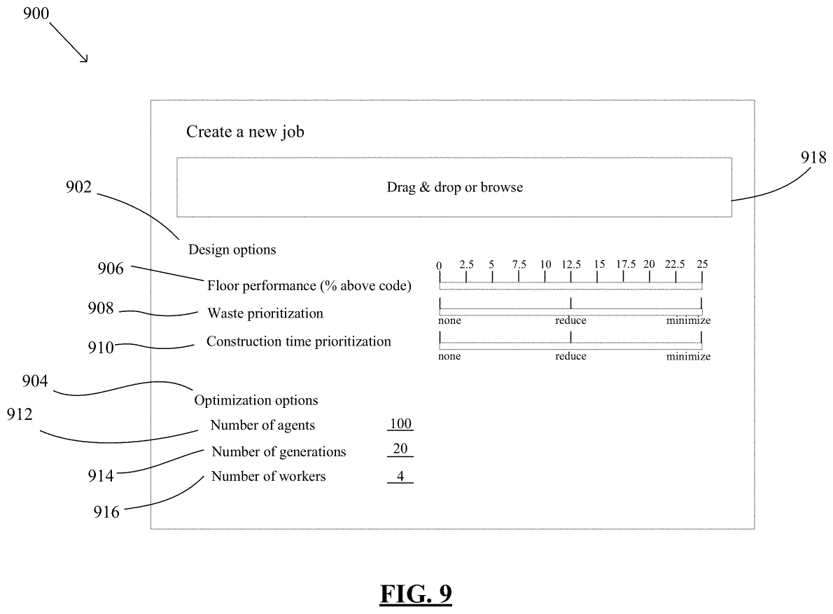

FIG. 9 illustrates a graphical user interface example for receiving the user-specified framing requirements for evaluation at step 606 of the framing optimization method 600. The graphical user interface (GUI) 900 may include two main sections, customizable by users: design options 902 and optimization options 904. In design options 902, the user may modify floor performance 906 as a percentage of the code, the code being the construction principles or a standard. An example of the standard is load A value of 0 can mean the generated agents need to minimally meet the standard. The user may prefer the plan to be above the standard. For instance, a plan with a floor performance value of 10 means the construction principles' parameters are tightened by 10% and the floor will therefore perform approximately 10% better than the construction standard minimally requires. Examples of the parameter include deflection, strength, and/or vibrational performance. For example, such parameters can be defined by the standard. Other example parameters may include the distance between joists, material strength, material depth, fire, acoustic or insulation performance of the floor components etc. The design options 902 may also include waste prioritization 908 and construction time prioritization 910, which are values considered when computing the function (fitness or loss) for the agent in the evaluation process. The waste prioritization 908 determines whether it is desired to have reduced waste or minimized floor component waste. Therefore, waste prioritization 908 takes account of waste management in the optimizing function, accounting for the offcuts that may be generated when the primary, secondary or panel products used in the floor are cut from longer or larger standard sized pieces and which cannot be reused. If waste prioritization 908 is set to “none”, the framing optimization method optimizes the cost of the primary and secondary frame members and the panel products without taking into account the cost of the waste offcuts generated. If the waste prioritization 908 is set to “minimize” the framing optimization method optimizes the function such that the primary and secondary frame members and the panel products are placed so that the cost of waste offcuts generated (at full value) is taken account of in the function. However, if the waste prioritization 908 is set to “reduce”, the cost of waste offcuts generated is taken account of at partial value, so the framing optimization method generates a plan with a function value between that would which have been generated for the “none” setting and the “minimize” setting.

Similarly, construction time prioritization 910 determines whether it is desired to have reduced time or minimum time for construction of the floor on the job site. For example, construction time prioritization 910 takes into account the degree to which secondary frame members are set-out for the edges of the panel products (e.g. affecting the amount of panel product cutting required). If construction time prioritization 910 is set to “none”, the framing optimization method optimizes the number of secondary frame members without taking into account the number of panel product cuts required. If the construction time prioritization 910 is set to “minimize” the framing optimization method optimizes the function such that the secondary frame members are placed so that panel products start and end at the centers of the secondary frame members, hence minimal panel product cuttings. However, if the construction time prioritization 910 is set to “reduce”, the framing optimization method generates a plan with a function value between that which would have been generated for the “none” setting and the “minimize” setting.

Other optimization options 904 may also include parameters controlling the framing optimization method such as number of agents 912, number of generations 914, and number of workers 916. The number of agents 912 parameter controls the number of agents in the initial population step 602 in framing optimization method 600. For instance, the number of generated second preliminary plans generated by the secondary frame member generator module 204. Further, the number of generations 914 parameter controls the maximum number of iterations the framing optimization method 600 undergoes before selecting the plan, assuming no plan with global minima was generated. The number of workers 916 parameter controls the number of cores to undertake parallel processing during framing optimization method 600. Further, the optimization options 904 can include options such as material type (not shown), primary frame member original uncut dimension value (not shown), original uncut secondary frame member dimension value (not shown), panel product original uncut dimension value (not shown), etc. Further, the graphical user interface 900, receives in the drag and drop or browse 918 the layout of the floors, which has the boundaries of a framing task that is used by the framing optimization method 600.

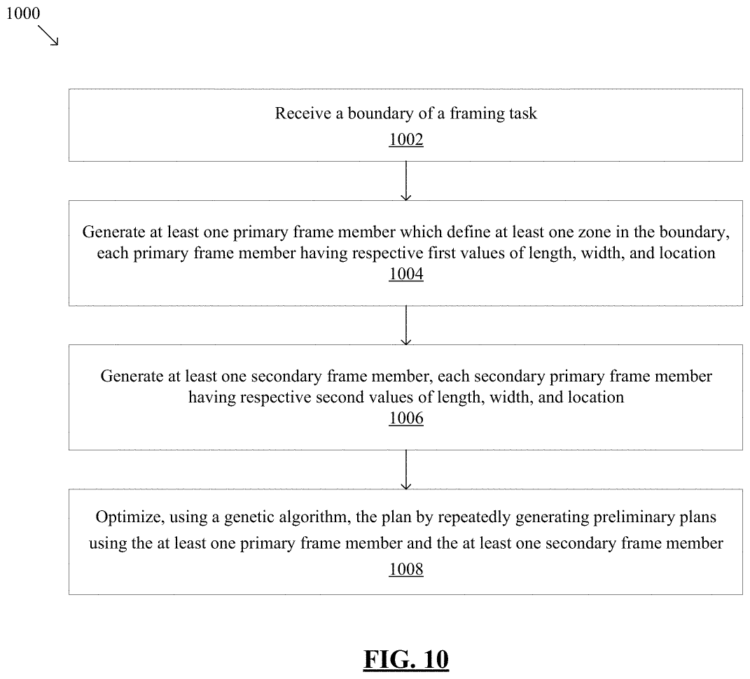

FIG. 10 is a flowchart of a framing optimization method 1000 performed in the framing optimization module 118 by the processing device 105. The processing device 105 receives, in a primary frame member generator module 202, a boundary of a framing task at step 1002. In example embodiments, the framing task is the generation of a floorplan.

At step 1004, the processing device 105 generates, in the primary frame member generator module 202, at least one primary frame member, which defines at least one zone in the boundary. Each primary frame member has respective first values of length, width, and location. Once the primary frame member is generated, the output of which is at least one first preliminary plan. The at least one first preliminary plan is provided to the secondary frame member generator module 204.

At step 1006, the processing device 105 generates, in the secondary frame member generator module 204, at least one secondary frame member. The secondary frame member has respective second values of length, width, and location. The output of the secondary frame member generator module 204 is at least one second preliminary plan. The at least one second preliminary plan is provided to an optimizer module 206 to generate a plan.

At step 1008, the processing device 105 optimizes, in the optimizer module 206, using a genetic algorithm, the plan by repeatedly generating preliminary plans using the at least one primary frame member and the at least one secondary frame member. The optimizer module 206 generates a plan having at least one primary frame member and at least one secondary frame member for the framing task within the boundary. In an example, the processing device 105 outputs the plan to the output device 116, a user device, or a display device (not shown here).

Another example embodiment is a method for using the framing optimization method 1000 of FIG. 10 for generating plans for floors during building construction. In such example embodiment, the method 1000 includes the processing device 105 receiving layouts of floors of a building, such as a house. More generally, receiving boundaries of a framing task. Each layout includes walls, posts, and frame-free zones. Frame-free zones may be a staircase or a chimney. In this example, the method 1000 includes generating a plan for each floor having beams and joists. For identical floors, one plan can be generated for one floor and re-used for another identical floor. The plan may be optimized, for example, to have reduced material cost. The genetic algorithm is used to generate the plan. In an example, the method 1000 includes constructing a building using the generated plan for each floor, by way of manual work (e.g. workers) and/or automated work (e.g. machinery, robots and equipment). After construction of the plan for the building's floor, the panel products can be installed and additional flooring can be laid on the panel products, such as hardwood, tile, carpet, concrete, paint, staining/sealing, etc.

The framing optimization method described above relies on a genetic algorithm. Another example embodiment uses a machine learning model to generate the plan (flooring layout). For example, a machine learning model may be used to generate primary frame members and secondary frame members, and perform optimization to select the primary and secondary frame members. This machine learning model may use a model trained from a training dataset to generate the primary frame members and the secondary frame members based on optimizing the costs described above such as one or a combination of material, process, wastage, and/or delivery costs. The described genetic algorithm may itself be regarded as a type of such machine learning model, or it may be used to create a training dataset upon which alternative machine learning models to be trained.

In example embodiments, other machine learning models can be used including supervised, unsupervised, and semi-supervised such as neural networks, deep neural networks, graph neural networks, support vector machine, Gaussian mixture models and others that can be trained for selecting and generating data points (members).

It will be understood that, although the terms first, second, third, etc., may be used herein to describe various elements, these elements should not be limited by these terms. These terms are used to distinguish one element from another. Thus, a first element can be termed a second element without departing from the example embodiments. As used herein, the term “and/or” includes any and all combinations of one or more of the associated listed items.

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The functions of the various elements shown in the figures, including any functional block labelled as a “processing device,” may be provided through the use of dedicated hardware as well as hardware capable of executing instructions in association with appropriate software instructions. When provided by a processing device 105, the functions may be provided by a single dedicated processor, by a single shared processor, or by a plurality of individual processors, some of which may be shared. In some implementations of the present technology, the processing device 105 may be a general-purpose processor, such as a central processing unit (CPU) or a processor dedicated to a specific purpose, such as a digital signal processor (DSP). Moreover, explicit use of the term a “processing device” should not be construed to refer exclusively to hardware capable of executing software and may implicitly include, without limitation, an application-specific integrated circuit (ASIC), a field-programmable gate array (FPGA), a read-only memory (ROM) for storing software, a random access memory (RAM), and non-volatile storage. Other hardware, conventional and/or custom, may also be included.

Software modules, or simply modules or units which are implied to be software, may be represented herein as any combination of flowchart elements or other elements indicating the performance of process steps and/or textual description. Such modules may be executed by hardware that is expressly or implicitly shown. Moreover, it should be understood that a module may include, for example, but without limitation, computer program logic, computer program instructions, software, stack, firmware, hardware circuitry, or a combination thereof, which provides the required capabilities. It will further be understood that a “module” generally defines a logical grouping or organization of related software code or other elements, as discussed above, associated with a defined function. Thus, one of ordinary skill in the relevant arts will understand that particular code or elements that are described as being part of a “module” may be placed in other modules in some implementations, depending on the logical organization of the software code or other elements and that such modifications are within the scope of the example embodiments.

It should also be noted that as used herein, the term “optimize” means to improve. It is not used to convey that the technology produces the objectively “best” solution, but rather that an improved solution is produced. In the context of memory access, it typically means that the efficiency or speed of memory access may be improved.

As used herein, the term “determine” generally means to make a direct or indirect calculation, computation, decision, finding, measurement, or detection. In some cases, such a determination may be approximate. Thus, determining a value indicates that the value or an approximation of the value is directly or indirectly calculated, computed, decided upon, found, measured, detected, etc. If an item is “predetermined” it is determined at any time prior to the instant at which it is indicated to be “predetermined.”

Example embodiments may be implemented as a system, a method, and/or a computer program product. The computer program product may include a computer-readable storage medium (or media) storing computer-readable program instructions that, when executed by a processing device 105, cause the processing device 105 to carry out aspects of the example embodiments. The computer-readable storage medium may be, for example, an electronic storage device, a magnetic storage device, an optical storage device, an electromagnetic storage device, a semiconductor storage device, or any suitable combination of these. A non-exhaustive list of more specific examples of the computer-readable storage medium includes a portable computer disk, a hard disk, a random access memory (RAM), a read-only memory (ROM), a flash memory, an optical disk, a memory stick, a floppy disk, a mechanically or visually encoded medium (e.g., a punch card or bar code), and/or any combination of these. A computer-readable storage medium, as used herein, is to be construed as being a non-transitory computer-readable medium. It is not to be construed as being a transitory signal, such as radio waves or other freely propagating electromagnetic waves, electromagnetic waves propagating through a waveguide or other transmission media (e.g., light pulses passing through a fiber-optic cable), or electrical signals transmitted through a wire.

It will be understood that computer-readable program instructions can be downloaded to respective computing or processing devices from a computer-readable storage medium or to an external computer or external storage device via a network, for example, the Internet, a local area network, a wide area network and/or a wireless network. A network interface in each computing/processing device may receive computer-readable program instructions via the network and forwards the computer-readable program instructions for storage in a computer-readable storage medium within the respective computing or processing device. Computer-readable program instructions for carrying out operations of the example embodiments may be assembler instructions, machine instructions, firmware instructions, configuration data for integrated circuitry, or either source code or object code written in any combination of one or more programming languages.

All statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes that may be substantially represented in computer-readable program instructions. These computer-readable program instructions may be provided to a processing device 105 or other programmable data processing apparatus to produce a machine, such that the instructions, which execute via the processing device of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowcharts, flow diagrams, state transition diagrams, pseudo-code, and the like.

The computer-readable program instructions may also be loaded onto a computer, other programmable data processing apparatus or other devices to cause a series of operational steps to be performed on the computer, other programmable apparatus or other devices to produce a computer-implemented process, such that the instructions which execute on the computer, other programmable apparatus, or other device implement the functions/acts specified in the flowcharts, flow diagrams, state transition diagrams, pseudo-code, and the like.

In some alternative implementations, the functions noted in flowcharts, flow diagrams, state transition diagrams, pseudo-code, and the like may occur out of the order noted in the figures. For example, two blocks shown in succession in a flowchart may, in fact, be executed substantially concurrently, or the blocks may sometimes be executed in the reverse order, depending upon the functionality involved. It will also be noted that each of the functions noted in the figures and combinations of such functions can be implemented by special purpose hardware-based systems that perform the specified functions or acts or by combinations of special-purpose hardware and computer instructions.

It will be understood that, although the embodiments presented herein have been described with reference to specific features and structures, various modifications and combinations may be made without departing from the example embodiments. The specification and drawings are, accordingly, to be regarded simply as an illustration of the discussed implementations or embodiments and their principles, and are contemplated to cover any and all modifications, variations, combinations or equivalents that fall within the scope of the example embodiments.

1. A framing optimization method comprising:
receiving a boundary of a framing task; and
generating a plan having at least one primary frame member and at least one secondary frame member for the framing task within the boundary, including:
generating at least one primary frame member which defines at least one zone in the boundary, each primary frame member having respective first values of length, width, and location,
generating at least one secondary frame member, each secondary frame member having respective second values of length, width, and location, and
optimizing, using a genetic algorithm, the plan by repeatedly generating preliminary plans using the at least one primary frame member and the at least one secondary frame member.

2. The framing optimization method of claim 1, wherein the at least one secondary frame member is supported by at least one of the at least one primary frame member.

3. The framing optimization method of claim 1, wherein the boundary includes walls and posts.

4. The framing optimization method of claim 1, wherein the optimizing meets specified framing requirements which include deflection, strength, and/or vibrational performance.

5. The framing optimization method of claim 4, wherein the specified framing requirements comprise a minimum requirement for meeting a standard.

6. The framing optimization method of claim 1, further comprising receiving user-specified framing requirements from a graphical user interface for the generating the plan.

7. The framing optimization method of claim 6, wherein the user-specified framing requirements include a number of agents for the genetic algorithm.

8. The framing optimization method of claim 6, wherein the user-specified framing requirements include a number of iterations for the genetic algorithms.

9. The framing optimization method of claim 1, wherein the optimizing of the plan is performed, for each of the preliminary plans, by generating another one or more of the preliminary plans, by at least one of:
generating another at least one primary frame member;
generating another at least one secondary frame member;
removing one or more of the at least one primary frame member;
removing one or more of the at least one secondary frame member;
changing one or more of the first values of the length, the width, or the location of one or more of the at least one primary frame member; or
changing one or more of the second values of the length, the width, or the location of one or more of the at least one secondary frame member.

10. The framing optimization method of claim 1, wherein the optimizing of the plan is performed, for each of the preliminary plans, by generating another one or more of the preliminary plans, by at least two of:
generating another at least one primary frame member;
generating another at least one secondary frame member;
removing one or more of the at least one primary frame member;
removing one or more of the at least one secondary frame member;
changing one or more of the first values of the length, the width, or the location of one or more of the at least one primary frame member; or
changing one or more of the second values of the length, the width, or the location of one or more of the at least one secondary frame member.

11. The framing optimization method of claim 1, wherein the optimizing of the plan is performed, for each of the preliminary plans, by generating another one or more of the preliminary plans, by all of:
generating another at least one primary frame member;
generating another at least one secondary frame member;
removing one or more of the at least one primary frame member;
removing one or more of the at least one secondary frame member;
changing one or more of the first values of the length, the width, or the location of one or more of the at least one primary frame member; and
changing one or more of the second values of the length, the width, or the location of one or more of the at least one secondary frame member.

12. The framing optimization method of claim 1, wherein the optimizing of the plan further comprises optimizing a function based on one or more cost values of material, process, wastage, or delivery.

13. The framing optimization method of claim 12, wherein the optimizing of the plan optimizes a loss function.

14. The framing optimization method of claim 13, wherein optimizing the loss function includes determining global minima.

15. The framing optimization method of claim 12, wherein the optimizing of the plan optimizes a fitness function.

16. The framing optimization method of claim 15, wherein the optimizing fitness function includes determining global optima.

17. The framing optimization method of claim 1, wherein the optimizing of the plan further comprises optimizing a reduction in cost of material cutting of the at least one primary frame member and/or the at least one secondary frame member.

18. The framing optimization method of claim 1, wherein the optimizing of the plan further comprises optimizing a reduction in cost of material cutting of panel products to be supported by the at least one primary frame member or the at least one secondary frame member.

19. The framing optimization method of claim 1, wherein the plan is a floorplan.

20. The framing optimization method of claim 1, wherein:
the framing task is floorplan framing;
each of the at least one primary frame member is a beam; and
each of the at least one secondary frame member is a joist.

21. The framing optimization method of claim 1, wherein the receiving of the boundary further comprises receiving at least one frame-free zone, the at least one frame-free zone comprising a second boundary of the frame-free zone within the boundary of the framing task, passing the at least one primary frame member or the at least one secondary frame member through the at least one frame-free zone violates construction principles.

22. The framing optimization method of claim 21, wherein the at least one primary frame member is generated along the second boundary of the frame-free zone.

23. The framing optimization method of claim 1, wherein the generating of the at least one primary frame member and the generating the at least one secondary frame member is performed using a machine learning model configured, through training from a training dataset, to generate the at least one primary frame member and the at least one secondary frame member.

24. The framing optimization method of claim 1, wherein the generating of the at least one primary frame member or the generating of the at least one secondary frame member is performed by assigning random values to the first values of the at least one primary frame member and the second values of the at least one secondary frame member.

25. The framing optimization method of claim 1, wherein the generating of the at least one primary frame member or the generating of the at least one secondary frame member is performed by assigning values to the first values of the at least one primary frame member and the second values of the at least one secondary frame member heuristically gathered from persons experienced in producing plans for assigning values to the first values of the at least one primary frame member and the second values of the at least one secondary frame member.

26. The framing optimization method of claim 1, wherein the optimizing of the plan using the genetic algorithm is performed over multiple iterations, each iteration of the genetic algorithm comprising generating at least two preliminary plans, each preliminary plan being generated by:
crossover between two preliminary plans of a previous iteration performed by swapping the at least one primary frame member and the at least one secondary frame member for the at least one zone between the two preliminary plans.

27. The framing optimization method of claim 1, wherein the optimizing of the plan using the genetic algorithm is performed over multiple iterations, each iteration of the genetic algorithm comprising generating at least one preliminary plan, each preliminary plan being generated by:
a first level mutation of one of the at least one preliminary plan by regenerating the at least one primary frame member and the at least one secondary frame member from the at least one zone.

28. The framing optimization method of claim 1, wherein the optimizing of the plan using the genetic algorithm is performed over multiple iterations, each iteration of the genetic algorithm comprising generating at least one preliminary plan, each preliminary plan being generated by:
a second level mutation of one of the at least one preliminary plan by introducing changes to at least one of the first values of the at least one primary frame member or at least one of the second values of the at least one secondary frame member.

29. A framing optimization system comprising:
a processing device; and
a memory coupled to the processing device, the memory tangibly storing thereon executable instructions that, when executed by the processing device, cause the processing device to:
receive a boundary of a framing task; and
generate a plan having at least one primary frame member and at least one secondary frame member for the framing task within the boundary, including:
generating at least one primary frame member which defines at least one zone in the boundary, each primary frame member having respective first values of length, width, and location,
generating at least one secondary frame member, each secondary frame member having respective second values of length, width, and location, and
optimizing, using a genetic algorithm, the plan by repeatedly generating preliminary plans using the at least one primary frame member and the at least one secondary frame member.

30. A framing optimization method comprising:
receiving a boundary of a framing task; and
generating, using a machine learning model, a plan having at least one primary frame member and at least one secondary frame member for the framing task within the boundary, including:
generating at least one primary frame member which defines at least one zone in the boundary, each primary frame member having respective first values of length, width, and location, and
generating at least one secondary frame member, each secondary frame member having respective second values of length, width, and location.

31. The framing optimization method of claim 30, wherein the machine learning model optimizes the plan based on one or more cost values of material, process, wastage, or delivery.

32. The framing optimization method of claim 30, wherein the machine learning model is a genetic algorithm.

33. The framing optimization method of claim 30, wherein the at least one secondary frame member is supported by at least one of the at least one primary frame member.

34. (canceled)
